(19) United States
(12) Patent Application Publication
(10) Pub. No.: US 2006/0116075 A1
(43) Pub. Date: Jun. 1, 2006

(54) Bluetooth broadcast data stream to multiple bluetooth mobile terminals

(76) Inventor: Francesco Gallo, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/538,575

(22) PCT Filed: Nov. 20, 2003
(86) PCT No.: PCT/IB03/05461

§ 371 Date: Jun. 15, 2005

(30) Foreign Application Priority Data
Dec. 18, 2002 (EP) 02080362.3

(51) Int. Cl. H04Q 7/00; H04B 7/00

(52) U.S. Cl. 455/41.2; 370/331

(57) ABSTRACT

The invention enables the use of Bluetooth (BT) for broadband data streaming applications. A BT base station BS-A with a BT-slave attached and at least one BS, providing streaming data. A BT slave attached to the BS-A receives network information based on which it can handover to a suitable BT BS, which provides the streaming data. Since only 7 active BT slaves can be supported by a BT BS, the BS will have to perform a park operation on the BT slaves, if there are more than 7 slaves. During park mode the BT slave can still receive broadband data, which is incorporated in the beacon packet transmitted by the BS. In order to avoid that the link between the parked BT slave and the BS is terminated due to link supervision timeout, the parked slaves must be unparked and parked again, whereby the link supervision timeout is reset. A scheduling algorithm is disclosed.

The invention relates to the field of broadcasting streams of data to one or more receivers using the Bluetooth technology.

Bluetooth (BT, see [2]) is a short-range radio link intended to replace cables connecting portable and/or fixed electronic devices. Key features are robustness, low complexity, low power, and low cost. The Bluetooth system has been developed and implemented in many devices: personal digital assistants (PDAs), notebooks, cellular phones and others.

The Bluetooth system is becoming more and more popular not only as a cable replacement technology (e.g. between the PC, the mouse, the keyboard and the printer) but also for creating wireless networks that users can exploit for receiving and transmitting data. This radio technology supports up to seven mobile terminals (MTs) connected to a single base station (BS) to exchange information.

The Bluetooth system provides a point-to-point connection (with only two Bluetooth units involved), or a point-to-multipoint connection. In the point-to-multipoint connection, the channel is shared among several Bluetooth units. Two or more units sharing the same channel form a piconet. One Bluetooth unit acts as the master of the piconet, whereas the other unit(s) acts as slave(s). Up to seven slaves can be active in the piconet. In addition, many more slaves can remain locked to the master in a so-called parked state. These parked slaves cannot be active on the channel, but remain synchronized to the master. The master controls the channel access both for active and parked slaves. Multiple piconets with overlapping coverage areas form a scattemet. Each piconet can only have a single master. However, slaves can participate in different piconets on a time-division multiplex basis. In addition, a master in one piconet can be a slave in another piconet. ([2] page 41-42).

Glossary

Base station (BS): a device that provides wireless connectivity to a fixed backbone. It is a network layer device (access router).

Mobile terminal (MT): a mobile device (PDA, notebook or cellular phone) that using Bluetooth is connected to base stations and exchange data or receive information. Handover: procedure that enables wireless terminals to switch automatically between two base stations.

Router: a device capable of computing routes and forward packets at the network layer.

Broadcast Channel: a set of broadcast data sent from one or more base stations.

Piconet: Two or more units sharing the same channel are said to form a piconet.

Park mode: When a slave does not need to participate on the piconet channel, but still wants to remain synchronized to the channel, it can enter the park mode, which is a low-power mode with very little activity in the slave.

Slot: Bluetooth time unit equal to 625 μs.

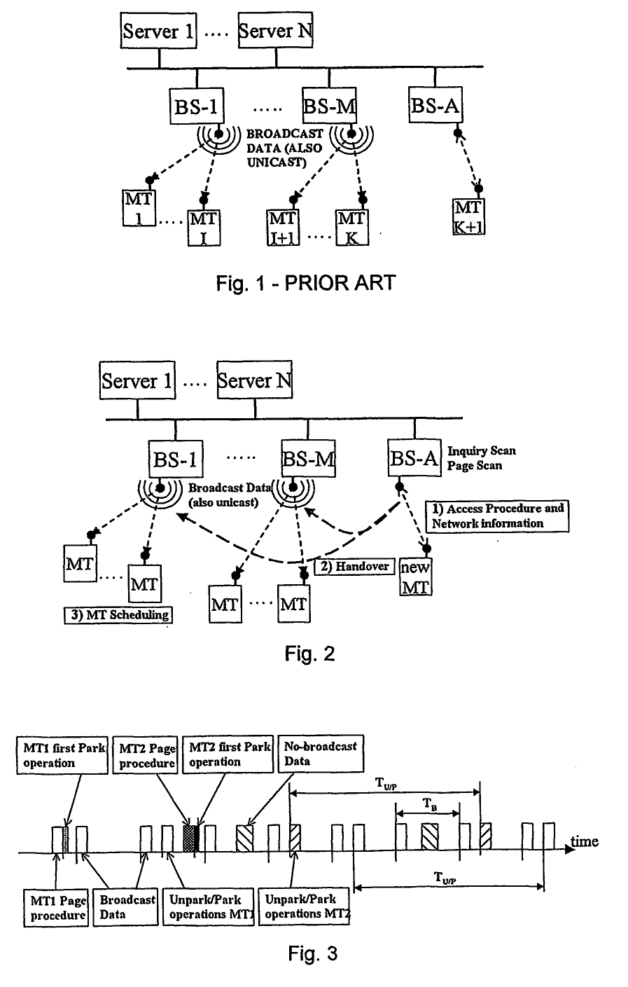

A prior art situation is shown in FIG. 1. It is composed of a fixed network of Bluetooth base stations (base station A, base station x with 1≦x≦M) and servers (Server x with 1≦x≦N). The Access base station (BS-A) is dedicated to establish a connection to incoming mobile terminals (mobile terminal x with 1≦x≦K+1) and manage them, whereas base station x send broadcast and also other data (for example unicast). On the fixed network one or more servers transmit broadcast information to base stations.

The prior art situation in FIG. 1 raises several problems relating to data streaming broadcasting and to managing the network (Server x, base station x, base station A, and active, parked or just connected, mobile terminals). Problems are listed below.

The parked slave scan window and the park beacon slots (see [2] page 112-119) have to be synchronized together with the broadcast transmissions from the servers to avoid data loss and long stream delays. For example, in a conference room with broadcast of audio, if audio data is generated every 100 ms then the park beacon slots have to be available at least every 100 ms and also the slave scan window has to be open at least every 100 ms for all parked mobile terminals (MTs) that are supposed to receive the information.

The number of park mode devices is limited by
1) the link supervision timeout (see [2] page 1024),
2) the throughput of broadcast data to send, and
3) the handovers of incoming mobile terminals from base station A to base station x.

To avoid triggering of the link supervision timeout (default value 20 s, maximum value 40.9 s) which disconnects the mobile terminal link, all parked slaves must be periodically unparked and, preferably immediately, parked again. If the number of parked slaves grows, the remaining bandwidth used to send broadcast data could be insufficient because of overloading of the previous essential unpark/park operations.

Scheduling of unpark/park actions has to be staggered to avoid that a large number of slaves need to be parked and unparked simultaneously. This situation could block the broadcast data and trigger several link supervision timeouts.

The application that sends the broadcast data on the base stations has to choose and indicate the best Bluetooth baseband packet type according to data streaming packet, throughput or Bluetooth link quality (not shown here). This point does not require a new HCI/LMP command but only a slight modification in the baseband and in the HCI Change Connection Packet Type to set the baseband packet type for a broadcast channel.

The network has to establish a connection with the incoming mobile terminals and switch them to the base stations that broadcast the information required by mobile devices. The involved operations do not have to influence heavily the Bluetooth broadcast transmissions (i.e. neither packet losses nor long delays are allowed).

Each Bluetooth broadcast packet is repeated N_{BC} times (see [2] page 71) to provide robustness against transmission errors. This parameter is very critical because it controls the Bluetooth bandwidth consumption and the broadcast transmission reliability. The N_{BC} management is not described here but should be taken into consideration during the broadcast network set-up. A large N_{BC} value implies higher error robustness and lower available application bit rate.

Active mobile terminals can receive no-broadcast data, (for example unicast) if it is necessary. The transmission of these data is co-ordinated with the transmission of broadcast data, handover operations and park/unpark procedures.

This invention describes the procedures for sending broadcast data using Bluetooth devices and to manage a network composed of many servers, base stations, and mobile terminals, to provide broadcast services.

The involved wireless and fixed networks are analyzed and algorithms for managing them and for increasing their efficiency are disclosed. In particular a method of sending broadcast data over Bluetooth link to a large number of mobile terminals is disclosed.

According to the invention, using the Bluetooth piconet broadcast channel and the park mode makes it possible to broadcast data to a large number of mobile terminals (about a hundred).

An example of application of Bluetooth broadcast service is a base station in a conference room that transmits one or several audio streams, in different languages, of the participants' conversation. In this situation the base station is the master and Bluetooth terminals (personal digital assistant, laptop and cellular phone) are slaves that receive and select the broadcast data. The situation can be extended using more base stations simultaneously to broadcast more information, manage the mobile terminal access in a more efficient way, and increase the number of supported mobile terminals.

FIG. 1 shows a prior art Bluetooth network with several Bluetooth base stations and several Bluetooth mobile terminals connected to the base stations,

FIG. 2 illustrates the invention used in the Bluetooth network in FIG. 1,

FIG. 3 shows an example of a timing diagram with two mobile terminals connected to the base station,

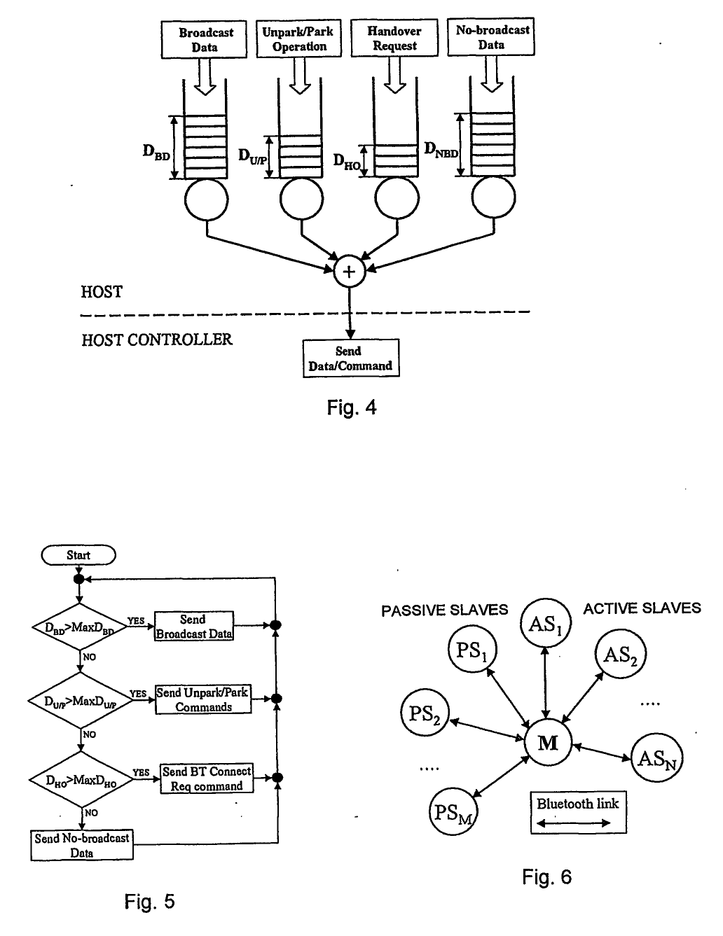

FIG. 4 shows the different delay queues involved in the invention,

FIG. 5 shows a flow chart of the invention, and

FIG. 6 illustrates a situation with both active and passive mobile terminals connected to a base station.

FIG. 1 shows a reference situation, which forms the basis of the invention and is used therein. The one or more servers (Server x, with 1≦x≦N) offer individual services and send corresponding individual broadcast data on the fixed network (for example an Ethernet segment). The information is sent using a connection less protocol (for example UDP, see [1] page 197-208), and multicast addresses to reach many destinations sending one packet only.

The Access base station (BS-A) provides the Bluetooth network access to new mobile terminals that request access to the broadcast network. After a new connection creation the base station A sends to the just connected mobile terminal some information about:
1) the broadcast data provided by the base stations (see below),
2) how to configure the mobile terminal to receive this data and
3) how to perform the handover (see [3]) to the base station with the requested broadcast information.

One or more base stations send broadcast data (base station x, with 1≦x≦M) to the mobile terminals. The base station number M is chosen according to the broadcast information sent from the servers, the number of supported mobile terminals, and the network covered area. The base stations are multicast Access Routers (ARs) that perform a multicast routing (see [1] page 319-352) between the wireless and fixed interfaces, for example between Bluetooth and an Ethernet segment. Transmitting broadcast data can be the same for all base stations or can change from one base station to another.

The mobile terminals (MTs) can be many devices (PDA, laptop, cellular phone with a Bluetooth module) where it is installed a client application to receive and process the broadcast data, a software to manage the wireless network access, the Bluetooth handover daemon and the information about the broadcast network services (see next chapter). For example looking at FIG. 1, after a successful connection creation to base station A the mobile terminal K+1 will download some information about the broadcast channels provided from the base station x and then it will start the handover to the base station with the most interesting channel.

By means of a file descriptor or using a data sharing protocol (not defined here) among the devices (Servers and base stations) on the fixed network, the base station A on FIG. 1 knows the base station x, the Server x, the mobile terminals connected to the base stations and the services provided by the network. This information is used by base station A to manage the incoming mobile devices that requests access at the broadcast network.

The park mode and the Bluetooth piconet broadcast (see [2] page 71, 112-119 and 555-557) are used respectively to support more than 7 slaves per piconet and to send broadcast data to mobile terminals (mobile terminal x) both in active and park mode. The invention comprises the following 4 sections (see FIG. 2):

0. Fixed/Wireless Network Configurations

The Server x (on FIG. 2) sends the broadcast information using e.g. a well-known multicast Internet Protocol (IP) address and a specified dimension of the data packets. The base station x is a multicast router that filters the IP datagrams from the fixed network allowing only the packets with determined multicast addresses. This means that the multicast addresses are associated with the broadcast information types (broadcast channels).

The applications on the mobile terminals connected with the base station x will use this IP multicast address to receive and identify the broadcast channel. These associations (IP multicast address, broadcast channels) are sent to the new mobile terminals from base station A during the access procedure (see next section).

The dimension of the IP multicast packets should match the Bluetooth (BT) baseband packet payload used by base station x to avoid useless bandwidth consumption sending Bluetooth packet not completely full. This point only requires a slight modification in the Bluetooth baseband and in the HCI Change Connection Packet Type to set the baseband packet type of the broadcast channel (see [2] page 583).

1. Access Procedure and Network Information

The access procedure describes how an incoming mobile terminal can establish a broadcast connection and how the base station A can meet such request.

The Access Base Station (BS-A on FIG. 2) is in inquiry scan state and page scan state (see [2] page 96-109), these states are used to receive all connection requests from mobile terminals that requests access to the broadcast network.

To access at the broadcast network the mobile terminal performs the following algorithm:

First, the mobile terminal performs the inquiry procedure to know the nearer base station A then it will start the page procedure to create a Bluetooth link.

When the connection is established, the access base station A sends several network information about the available broadcast channels with short content descriptions and the associated IP multicast addresses (see previous section).

The broadcast channel is selected either manually or automatically, and the handover to the base station x (see FIG. 2) that provides the searched service is performed. If more base stations transmit the same broadcast data the access base station A can activate the handover procedure moving the mobile terminals according to an own policy. For example a policy could split up the mobile terminals so that the base stations (base station x) have the same number of connected devices.

The proposed invention does not resolve security issues that the system network of FIG. 2 can raise.

2. Handover Procedure

The handover procedure describes when an incoming mobile terminal is connected and the information about the broadcast channels is retrieved from base station A, it performs a handover to the base station x with the requested broadcast channel.

The handover procedure is similar to that described in [3]. When the incoming mobile terminal has chosen the broadcast channel, a page request is sent to the base stations (base station x on FIG. 2) that provides the required service according to the adopted policy (see previous section, 3^{rd} point). The base stations will perform the page procedure and the mobile terminal will start the page scan procedure.

Base station page mode is carried out in such a way the broadcast packets are not lost or unacceptably delayed, using short page timeout (about 10 or 20 ms) repeated periodically as long as the handover timeout is triggered or the mobile terminal is connected. The page procedures are managed by means of the mobile terminal scheduling (see next section).

After the Bluetooth link establishment between base station and mobile terminal, the client application on the mobile terminal side can start to receive and process the broadcast data and it can enter park mode. The parked slave scan window is set to allow a continuous scan without interruptions avoiding a complicated synchronization among the piconet parked mobile terminals and the broadcast data.

3. Mobile Terminal Scheduling

The mobile terminal scheduling describes how to support more than 7 slaves per piconet; for this purpose the park mode is used. Parked mobile terminals return periodically in active state to reset the link supervision timeout. These unpark/park operations are staggered by means of mobile terminal scheduling to avoid the timeout trigger and broadcast packet losses. Mobile terminal scheduling manages and synchronizes also no-broadcast data, handover procedures and the broadcast transmission as well.

When the mobile terminal goes into park mode it has to perform the unpark/park operations periodically to reset the link supervision timeout (in the base station) and avoid the closing of its Bluetooth link (see [2] page 603-604). Both the master and slave use the supervisionTO to monitor link loss. These actions, together with handover procedures, limit the number of Bluetooth parked devices and the total amount of the broadcast information per base station. To be able to supervise link loss, both the master and the slave use link supervision timers. Upon reception of a packet that passes the HEC check and has the correct AM_ADDR, the timer is reset. If at any time in connection state, the timer reaches the supervisionTO value, the connection is reset. The same timeout value is used for both SCO and ACL connections. The timeout period, supervisionTO, is negotiated at the LM level. Its value is chosen so that the supervision timeout will be longer than hold and sniff periods. Link supervision of a parked slave will be done by unparking and re-parking the slave.

A scheduling policy is implemented to distribute unpark, park, handover page operations and no-broadcast data among the broadcast transmissions avoiding simultaneous procedures that could unduly occupy the base station. This control is called mobile terminal scheduling and is illustrated in FIG. 3. In this figure every rectangle corresponds to a single action, for example a page procedure, an unpark/park operation, or a broadcast transmission. In the time diagram of FIG. 3, T_{B} is the period of the broadcast transmission, and T_{U/P} is the elapsed time between two consecutive unpark/park operations. Rectangles do not indicate a single Bluetooth packet but a set of packets needs to fulfil broadcast transmission, park/unpark and page operations (for example the rectangle with the label “MT1 Page procedure” is a set of packets to perform the page procedure and hence establish the connection).

When the mobile terminal has performed the handover, the base station (see base station 1 in FIG. 2) sets the periodic unpark/park operations. For example in FIG. 3 the mobile terminal 2 is put on park mode for the first time (black rectangle) after its Page procedure end (checkered black and white rectangle). In this situation the mobile terminal 2 periodical operations (black and white striped rectangles) start on the next interval because the base station has reserved it and the other ones every T_{U/P} slots (on average see below).

T_{U/P} depends on supervision timeout (TO) and T_{B}, where supervision timeout is the Bluetooth link supervision timeout (see [2] page 1017).

Mobile terminal scheduling algorithm is located on every host side of base stations that send broadcast data. It has to synchronize several operations: data stream broadcasting, no-broadcast data transmission, unpark/park procedures and handover requests. The handover requests include also an (fast) operation to immediately put the mobile terminal in park mode.

The solution according to the invention is depicted in FIG. 4. It comprises four main delay queues where the packets are stored and delayed. The four delays are:

D_{BD} is the queuing delay of the last data packet in the broadcast data queue,

D_{U/P} is the queuing delay of the last unpark/park commands in the unpark/park queue,

D_{HO} is the queuing delay of the last handover request in the handover request queue.

D_{NBD} is the queuing delay of the last data packet in the no-broadcast data queue,

For example if the broadcast data queue contains 10 packets and T_{B}=30 ms then D_{d}=10*T_{B}=300 ms, and if the unparklpark queue has 5 command sets and T_{B}=30 ms then D_{U/P}=5*T_{B}=150 ms. In this example the scheduling performs only one unpark/park operation between two broadcast transmissions, but several unpark/park operations or none at all can be performed.

FIG. 5 shows a flowchart of mobile terminal scheduling algorithm. It prescribes that:

The broadcast data packets arrive at the base station at time intervals T_{B} and are buffered in the broadcast data delay queue. In order to avoid quality degradation, the maximum broadcast data queuing delay MaxD_{BD} must be minimized to avoid buffer underflow at the receiver. The maximum broadcast data queuing delay MaxD_{BD} is chosen as a value shorter than the maximum allowable delay of the data streaming. The maximum allowable delay of the data streaming is equal to the time requested to empty the receiver buffer in the mobile terminals. Typically MaxD_{BD} is half of the maximum allowable delay of the data streaming. The broadcast packets of data received are buffered by the Bluetooth base station and transmitted with a broadcast data queuing delay (D_{BD}), and if the broadcast data queuing delay (D_{BD}) exceeds a predefined maximum broadcast data queuing delay (MaxD_{BD}), a buffered packet of data is broadcast.

Unpark/park commands are sent periodically at time intervals T_{U/P} to each mobile terminal. In order to avoid link supervision timeout trigger, the maximum queuing delay (MaxD_{U/P}) is chosen in the order of some seconds and depends on the supervision timeout. Below are given some park mode optimizations in three different situations when both active and parked slaves are connected to the same piconet. Unpark/park commands are buffered in the Bluetooth base station and transmitted with an unpark/park queuing delay (D_{U/P}) to the Bluetooth mobile terminal. If the broadcast data queuing delay (D_{BD}) does not exceed the predefined maximum broadcast data queuing delay (MaxD_{BD}), and if the unpark/park queuing delay (D_{U/P}) exceeds a predefined maximum unpark/park queuing delay (MaxD_{U/P}), a buffered unpark/park command is transmitted to the Bluetooth mobile terminal.

The maximum queuing delay of handover requests (MaxD_{HO}) is in order of some seconds. A mobile terminal usually requires only one handover, i.e. from the access base station A to base station x (see FIG. 2). The handover request also contains the HCI command to put the new mobile terminal into the park mode (see FIG. 3 checked black and white, and black rectangle). Handover requests requesting connection of the Bluetooth mobile terminal to a second Bluetooth base station are buffered in the Bluetooth base station and transmitted with a handover queuing delay (D_{HO}) to the Bluetooth mobile terminal. If the broadcast data queuing delay (D_{BD}) does not exceed the predefined maximum broadcast data queuing delay (MaxD_{BD}), and if the unpark/park queuing delay (D_{U/P}) does not exceed the predefined maximum unpark/park queuing delay (MaxD_{U/P}), and if the handover queuing delay (D_{HO}) exceeds a predefined maximum handover queuing delay (MaxD_{HO}), a buffered handover request is transmitted to the Bluetooth mobile terminal. Handover requests will be supplied from base station A during the access procedure but also in cases where it is desired to connect a Bluetooth mobile terminal to another Bluetooth base station.

No-broadcast data is sent with the lowest priority to the active mobile terminals. If the broadcast data queuing delay (D_{BD}) does not exceed the predefined maximum broadcast data queuing delay (MaxD_{BD}), and if the unpark/park queuing delay (D_{U/P}) does not exceed the predefined maximum unpark/park queuing delay (MaxD_{U/P}), and if the handover queuing delay (D_{HO}) does not exceed the predefined maximum handover queuing delay (MaxD_{HO}), then a no-broadcast data packet is transmitted to the Bluetooth mobile terminal. The associated queue delay (D_{NBD}) is not taken into consideration in the mobile terminal scheduling algorithm.

If a queue does not contain data, the delay D_{X} (D_{BD}, D_{U/P}, D_{HO}, or D_{NBD}) is set to 0. This feature is used below in the mobile terminal scheduling to skip the empty queue.

Constants MaxD_{BD}, MaxD_{U/P}, and MaxD_{HO} are chosen according to the maximum queuing delays of broadcast queue, unpark/park queue, and handover queue respectively. They are used to trigger the transmission of broadcast data, unpark/park commands, and handover requests. For example if the maximum queuing data delay (maximum D_{BD}) is 100 ms then MaxD_{BD} could be 50 ms or 70 ms, and if supervision timeout=40.5 s and T_{U/P}=20 s then MaxD_{U/P} could be 10 s (in this case the maximum D_{U/P} value is between MaxD_{U/P} and the supervision TO-T_{U/P}). MaxD_{U/P} is chosen in this way because the mobile terminals remain in park mode for about T_{U/P}+MaxD_{U/P}=30 s avoiding the Bluetooth link timeout due to supervision TO=40.5 s. MaxD_{HO} is not specified but can be bigger than the MaxD_{U/P}. mobile terminal page scan timeout must be set to this D_{HO} value.

The algorithm is based on the queuing delays. The first check is carried out on the broadcast data queue. If D_{BD}>MaxD_{BD} the data is sent and the D_{BD} is checked again. If D_{BD}<MaxD_{BD} the unpark/park queue delay (D_{U/P}) is checked. If D_{U/P}>MaxD_{U/P} the unpark/park commands are sent (see below for a complete definition of unpark/park commands) and the algorithm returns to start and checks D_{BD}, otherwise D_{HO} is checked. If D_{HO}>MaxD_{HO} the Bluetooth Connect Request command is sent to perform the Bluetooth handover; otherwise a no-broadcast data packet is transmitted. Every time a packet is sent the algorithm returns to start and checks the broadcast data queue. When a queue does not contain data the delay is set to 0 (D_{X}=0) and the relative condition (D_{X}>MaxD_{X}) is always false because MaxD_{X}>0.

Examples of Park Mode Optimizations

Bluetooth piconets can be composed of several slaves in active state (called active slave, AS) and many others in park mode (called parked slave, PS). During an unpark procedure it is possible to unpark 7 slaves minus the number of active slaves at the moment. If there are 7 active slaves, the unpark procedure is denied. To bypass this problem a certain number of active slaves are parked so that the same number of parked slaves can be unparked. If no active slaves are present only the unpark procedure of parked slaves is performed, in this case up to 7 slaves can be unparked simultaneously. When the number of active slaves is less than 7 and greater than 0 the park/unpark procedures are applied both active slaves and parked slaves but the number of involved active slaves are not equal to the number of parked slaves.

The park/unpark operations described in the section “mobile terminal scheduling” are a set of commands that includes both the unpark/park commands of parked slaves and the park/unpark commands of active slaves.

This section shows optimized algorithms, in term of speed and time, to perform the scheduled park/unpark operations with or without active slaves (see 2^{nd} queue on FIG. 4).

The reference situation is depicted in FIG. 6 where:

PS_{X} are slaves in park mode.

AS_{X} are slaves in active state.

N is the number of active slaves (from 0 to 7).

M is the number of parked slaves.

Three main cases are taken into consideration:

N=0, M>7 (No active slaves).

N=7, M>7 (Maximum number of active slaves).

1≦N≦6, M>7 (intermediate situation).

First case N=0, M>7, no active slaves

In this situation the park mode optimization consists in simultaneously unparking/parking the greatest possible number of mobile terminals, i.e. 7. With no active slaves it is possible to unpark/park up to 7 slaves simultaneously using only 2 commands (see [2] page 216-222). It is not allowed to unpark more than 7 slaves because in this way the Bluetooth piconet will be composed of more than 7 active slaves. Regarding FIG. 4 and FIG. 5 every time the unpark/park commands are sent (from the 2^{nd} queue) 7 parked slaves are unparked and parked.

Second case N=7, M>7, maximum number of active slaves

In this second case the piconet is completely occupied with the maximum possible number of active slaves, i.e. 7. To come back in active mode, parked slaves have to put one or more previously selected active slaves in park mode. The algorithm, used to choose the K active slaves to be put in park mode, is described below:
1) Looking at the 4^{th} queue in FIG. 4, the K active slaves to be put in park mode are those that satisfy one of these conditions:

a) They do not have any data packet in the 4^{th} queue for more time than the others.

b) They have data in the 4^{th} queue but it is newer than the others.
2) Park the K active slaves selected before.
b 3) Unpark/park K parked slaves (the same number of active slaves before parked).
4) Unpark the parked active slaves.

To reduce resource consumption (power and time) the park/unpark procedure has to involve a greatest number of active slaves and parked slaves. It means that the number K should be 7. For example, if K=1 the time to unpark/park 7 parked slaves is 13% more than the used time applying K=7 because in the first case it has to send 14 unpark/park commands in the second case only 2 ones.

Looking at the 2^{nd} queue in FIG. 4, the previous algorithm has to be applied for each unpark/park operations. This means that every time the parked slave unpark/park commands are sent an equal number of active slave park/unpark commands are performed, in the order described by the algorithm. The mobile terminal scheduling has to take into account the growth of park/unpark operations to avoid the piconet saturation.

Third case 1≦N≦6,M>7

In this situation it is possible to unpark/park 7-N parked slaves without parking/unparking any active slaves. Changing the value N it is possible to notice that to achieve good performance sometimes it is profitable to park/unpark a certain number of active slaves too.

TABLE 1
Time Gain if several active slaves are parked and unparked.

| N | AS_{P/U} ≧ | PS_{U/P} ≧ | Time Gain [%] ≧ |
|---|---|---|---|
| 1 | 0 | 6 | — |
| 2 | 0 | 5 | — |
| 3 | 0 | 4 | — |
| 4 | 4 | 7 | 8 |
| 5 | 3 | 5 | 14 |
| 6 | 2 | 3 | 28 |

Table 1 shows the achieved gains if several active slaves are parked and unparked:

N is the number of active slaves (from 0 to 7, see FIG. 6).

AS_{P/U} is the number of parked/unparked active slaves in a single transmission of park/unpark commands.

PS_{U/P} is the number of unpark/park parked slaves in a single transmission of unpark/park commands (see 2^{nd} in FIG. 4).

Time Gain is the gain obtained by unparking/parking PS_{U/P} parked slaves and parking/unparking AS_{P/U} active slaves compared to unparking/parking 7-N parked slaves only.

Using N=1, 2, 3 the gain is null, in these cases PS_{U/P}=7-N and AS_{P/U}=0.

Significant improvement is achieved with N>3. In these cases the Time Gain starts from 8%.

To choose the active slaves to park/unpark, the algorithm described in the “Second case N=7, M>7” sub-section is applied.

Like in the previous sub-section, if N=4, 5, 6 for each transmission of parked slave unpark/park commands a certain number of the active slave park/unpark commands are sent, but in this case AS_{P/U} is different from PS_{U/P}. The mobile terminal scheduling has to take into account this growth of park/unpark operations to avoid the piconet saturation.

Examples of Application

The invention involves the mobile terminals, the Base Stations (BSs) and Servers. In particular the mobile terminals only require a simple application to establish a connection with the access base station A (see FIG. 2), retrieve the information about the provided broadcast services, perform the handover to the corresponding base station x and receive the broadcast data.

Possible examples of applications are shown below:

An application service (as described above) comprising several base stations in a conference room, where each base station transmits one of several audio streams in different languages of the participants' conversation or of presentations and simultaneous translations thereof to the mobile terminals (personal digital assistant, laptop and cellular phone).

On an airplane for listening to a selected language of the television set using the headphone with own PDA or cellular phone.

In a museum tour to listen the explanation about the shown work of arts and retrieve useful data about the authors (for example the life, several images or short messages).

### CONCLUSIONS

Nowadays Bluetooth system is a radio technology implemented on many devices (Personal Digital Assistant PDA, laptop, cellular phone). The presented invention shows a method to provide broadcast information using Bluetooth (BT) technology and a system composed of several servers to supply broadcast data, and many Bluetooth base stations to send the information to more mobile tenninals.

### REFERENCES

[1] D. E. Comer, “Internetworking with TCP/IP”, Upper Saddle River, N.J., Prentice Hall, 1995.
[2] “Specification of the Bluetooth System, CORE”, version 1.1, Feb. 22, 2001, see: http://www.bluetooth.com/pdf/Bluetooth 11 Specifications Book.pdf
[3] “Enabling fast handovers among Bluetooth LAN access points”, Nat. Lab Technical Note TN2000/426. D. Melpignano, F. Gallo.

1. A method of operating a first Bluetooth base station and at least one Bluetooth mobile terminal connected to the first Bluetooth base station, wherein
the first Bluetooth base station receives packets of data and broadcasts received packets of data, and
each of the at least one Bluetooth mobile terminal receives the broadcast packets of data,
and wherein each of the at least one Bluetooth mobile terminal can be selectively controlled to enter either of a Bluetooth park mode and a Bluetooth active mode,
the method characterized by comprising the following steps:
controlling each of the at least one Bluetooth mobile terminal to enter the Bluetooth park mode, and subsequently
controlling each of the at least one Bluetooth mobile terminal in the Bluetooth park mode, at time intervals (T_{U/P}) shorter than a Bluetooth link supervision timeout, by--sending an unpark/park command to the Bluetooth mobile terminal to enter the Bluetooth active mode and to subsequently return to the Bluetooth park mode.

2. A method according to claim 1, characterized in that the broadcast packets of data received by the first Bluetooth base station are buffered and transmitted with a broadcast data queuing delay (D_{BD}), and
if the broadcast data queuing delay (D_{BD}) exceeds a predefined maximum broadcast data queuing delay (MaxD_{BD}), broadcasting a buffered packet of data.

3. A method according to claim 2, characterized in that the unpark/park commands are buffered in the first Bluetooth base station and transmitted with an unpark/park queuing delay (D_{U/P}) to the Bluetooth mobile terminal, and
if the broadcast data queuing delay (D_{BD}) does not exceed the predefined maximum broadcast data queuing delay (MaXD_{BD}), and
if the unpark/park queuing delay (D_{U/P}) exceeds a predefined maximum unpark/park queuing delay (MaxD_{U/P}),
transmitting a buffered unpark/park command to the Bluetooth mobile terminal.

4. A method according to claim 3, characterized in that handover requests requesting connection of the Bluetooth mobile terminal to a second Bluetooth base station are buffered in the first Bluetooth base station and transmitted with a handover queuing delay (D_{HO}) to the Bluetooth mobile terminal, and
if the broadcast data queuing delay (D_{BD}) does not exceed the predefined maximum broadcast data queuing delay (MaxD_{BD}),
if the unpark/park queuing delay (D_{U/P}) does not exceed the predefined maximum unpark/park queuing delay (MaxD_{U/P}), and
if the handover queuing delay (D_{HO}) exceeds a predefined maximum handover queuing delay (MaXD_{HO}),
transmitting a buffered handover request to the Bluetooth mobile terminal.

5. A method according to claim 4, characterized in that
if the broadcast data queuing delay (D_{BD}) does not exceed the predefined maximum broadcast data queuing delay (MaxD_{BD}), and
if the unpark/park queuing delay (D_{U/P}) does not exceed the predefined maximum unpark/park queuing delay (MaxD_{U/P}), and
if the handover queuing delay (D_{HO}) does not exceed the predefined maximum handover queuing delay (MaxD_{HO}),
transmitting a no-broadcast data packet to the Bluetooth mobile terminal.

6. A method according to claim 5, characterized in that the no-broadcast data packet is transmitted according to the upper layer of the Bluetooth protocol.

7. A method according to claim 1, characterized in that the data are broadcast as streaming data.

8. A Bluetooth base station capable of broadcasting data to at least one Bluetooth mobile terminal connected to the Bluetooth base station,
characterized in that the Bluetooth base station is capable of operating in accordance with the method of claim 1.
